(19) United States
(12) Patent Application Publication
(10) Pub. No.: US 2011/0001322 A1
(43) Pub. Date: Jan. 6, 2011

(54) SELF-CHARGING ELECTRICAL CAR

(76) Inventors: Sara Armani, Richmond Hill (CA); Fernando Armani, Richmond HIll (CA); Antonio Alvi Armani, Toronto (CA)

Correspondence Address: Fernando Armani, 79 Boake Trail, Richmond Hill, Ontario, L4B 3H1, CA

(21) Appl. No.: 12/497,618

(22) Filed: Jul. 3, 2009

(51) Int. Cl. H02K 7/18; F03G 7/08

(52) U.S. Cl. 290/1 R

(57) ABSTRACT

An energy recovery system for a vehicle comprises an arm mounted between a chassis of a vehicle and an axle of the vehicle. The arm is configured to pivot with respect to the chassis and the axle when the chassis is vertically displaced with respect to the axle. A one-way ratchet assembly couples the arm to an output shaft and is movable between an engaged position and a disengaged position. A torsion spring is coupled to the output shaft such that when the output shaft is rotated in a first direction, the torsion spring is tightened. An electromechanical assembly is configured to move the ratchet assembly from the engaged position to the disengaged position when the torsion spring reaches a pre-determined tightness, so that when the ratchet assembly is in the disengaged position, the torsion spring loosens and induces rotation of the output shaft in the second direction. A generator is coupled to the output shaft.

This application claims the benefit of a Canadian Patent Application filed on Jun. 26, 2009, which is hereby incorporated herein by reference.

### FIELD

The specification relates to an energy recovery system. More particularly, the specification relates to an energy recovery system for converting vehicle motion into electrical power, which may be usable to charge an electrical vehicle.

### INTRODUCTION

The following is not an admission that anything discussed below is prior art or part of the common general knowledge of persons skilled in the art.

U.S. Pat. No. 3,861,487 (to Gill) discloses a vehicle power system comprising a power generating unit carried by a vehicle for reaction to movements between parts of a vehicle to produce energy that is transmitted through a power reserve unit to electric generating means for translation into electrical energy, which augments the battery power pack that supplies current for an electric system on such a vehicle.

### SUMMARY

The following summary is provided to introduce the reader to the more detailed discussion to follow. The summary is not intended to limit or define the claims.

According to one broad aspect, an energy recovery system for converting vehicle motion into electrical power is provided. The energy recovery system comprises an arm mounted between a chassis of the vehicle and an axle of the vehicle. The arm is pivotably mounted at first and second opposed ends thereof and is configured to pivot with respect to the chassis and the axle when the chassis is vertically displaced with respect to the axle. A one-way ratchet assembly couples the arm to an output shaft. The ratchet assembly is movable between an engaged position and a disengaged position. In the engaged position, the ratchet assembly induces rotation of the output shaft in a first direction about a longitudinal axis thereof when the arm pivots in the first direction, and prevents rotation of the output shaft in a second direction opposite the first direction. In the disengaged position, the ratchet assembly does not prevent rotation of the output shaft in the second direction. A torsion spring is coupled to the output shaft such that when the output shaft is rotated in the first direction, the torsion spring is tightened and rotational energy of the output shaft is stored as potential energy in the torsion spring. An electromechanical assembly is coupled to the ratchet assembly. The electromechanical assembly is configured to move the ratchet assembly from the engaged position to the disengaged position when the torsion spring reaches a pre-determined tightness, so that when the ratchet assembly is in the disengaged position, the torsion spring loosens and induces rotation of the output shaft in the second direction. A generator is coupled to the output shaft and is configured to convert rotational energy of the output shaft into electrical energy.

The one-way ratchet assembly may comprise a pawl assembly moveable between a pawl assembly engaged position and a pawl assembly disengaged position. When the pawl assembly is in the pawl assembly engaged position, the pawl assembly induces the rotation of the output shaft in the first direction when the arm pivots in the first direction. The one-way ratchet assembly may further comprise a clutch assembly moveable between a clutch assembly engaged position and a clutch assembly disengaged position. When the clutch assembly is in the clutch assembly engaged position, the clutch assembly prevents the rotation of the output shaft in the second direction. The ratchet assembly is in the engaged position when the clutch assembly is in the clutch assembly engaged position and the pawl assembly is in the pawl assembly engaged position.

In some embodiments, the pawl assembly comprises a cylinder extending collinear to the output shaft and having a toothed bore extending longitudinally therethrough. The cylinder may be coupled to the second end of the arm such that when the arm pivots in the first direction, the cylinder rotates about a longitudinal axis thereof in the first direction.

The pawl assembly may further comprise a toothed pawl received in the toothed bore and engaging the toothed bore when the pawl assembly is in the pawl assembly engaged position. When the toothed pawl engages the toothed bore, rotation of the cylinder in the first direction induces orbital rotation of the toothed pawl in the first direction about the longitudinal axis of the cylinder. The toothed pawl may be coupled to the output shaft such that the orbital rotation of the toothed pawl in the first direction induces the rotation of the output shaft in the first direction.

The pawl assembly may further comprise a pivot pin about with the toothed pawl is pivotal. The orbital rotation of the toothed pawl may induce orbital rotation of the pivot pin about the longitudinal axis of the cylinder. The pivot pin may be mounted to the output shaft, such that that the orbital rotation of the toothed pawl in the first direction induces the rotation of the output shaft in the first direction via the pivot pin.

In some embodiments, when the pawl assembly is in the pawl assembly engaged position, the toothed pawl is pivoted about the pivot pin to a first pivotal position in which the toothed pawl engages the toothed bore. When the pawl assembly is in the pawl assembly disengaged position, the toothed pawl is pivoted about the pivot pin to a second pivotal position. The toothed pawl may be moved between the first pivotal position and the second pivotal position by movement of a plunger between a first angular position and a second angular position with respect to the toothed pawl. The plunger may be mounted to a control shaft extending collinear to the output shaft, and the plunger may be moved between the first angular position and the second angular position by rotation of the control shaft. The control shaft may be rotated by an electromechanical assembly.

In some embodiments, the clutch assembly comprises a first toothed surface mounted to the output shaft such that rotation of the output shaft in the first direction induces rotation of the first toothed surface in the first direction. The clutch assembly may further comprise a second toothed surface moveable towards and away from the first toothed surface by the electromechanical assembly. The second toothed surface may be rotationally fixed with respect to the output shaft. When the ratcheting assembly is in the engaged position, the second toothed surface may be moved towards the first toothed surface to engage the first toothed surface to prevent rotation of the first toothed surface in the second direction. When the ratcheting assembly is in the disengaged position, the second toothed surface may be moved away from the first toothed surface.

In some embodiments, the output shaft is coupled to the torsion spring by at least one gear.

In some embodiments, the torsion spring is at least partially received in a housing comprising at least one catch on an inner surface thereof. The torsion spring may be tightened by winding of a first end thereof about a spring axis, and a second end thereof may be releasably secured to the catch. In some embodiments, the spring reaches the predetermined tightness when a force required to maintain the second end of the spring secured to the catch is less than a force required to continue winding the first end of the spring. When the spring reaches the predetermined tightness, the second end of the spring may be released from the catch and the spring may rotate about the spring axis.

In some embodiments, at least one of the release of the second end of the spring from the catch and the rotation of the spring about the spring axis triggers the electromechanical unit to move the ratchet assembly from the engaged position to the disengaged position.

In some embodiments, the housing comprises a plurality of catches on the inner surface thereof and positioned around an inner perimeter thereof. When the second end of the spring is released from the catch and the spring rotates about the spring axis, the second end of the spring snaps into another of the catches. In such embodiments, the snapping of the spring into the other of the catches may trigger the electromechanical unit to move the ratchet assembly from the engaged position to the disengaged position.

In some embodiments, the catch is a recess formed in the inner surface of the housing, and the second end of the spring is releasably received in the recess.

In some embodiments, the system further comprises a battery coupled to the generator and configured to store the electrical energy.

In some embodiments, the arm is mounted directly to the chassis. In other embodiments, the arm is mounted to a suspension system of the automobile.

According to another broad aspect, an automobile is provided which comprises the energy recovery system described herein.

According to another broad aspect, an energy recovery system for converting vehicle motion into electrical power is provided. The energy recovery system comprises an arm mounted between a first portion of the vehicle and a second portion of the vehicle. The arm is pivotably mounted at first and second opposed ends thereof and is configured to pivot with respect to the first portion and the second portion when the first portion is vertically displaced with respect to the second portion. A one-way ratchet assembly couples the arm to an output shaft. The ratchet assembly is movable between an engaged position and a disengaged position. In the engaged position, the ratchet assembly induces rotation of the output shaft in a first direction about a longitudinal axis thereof when the arm pivots in the first direction, and prevents rotation of the output shaft in a second direction opposite the first direction. In the disengaged position, the ratchet assembly does not prevent rotation of the output shaft in the second direction. A torsion spring is coupled to the output shaft such that when the output shaft is rotated in the first direction, the torsion spring is tightened and rotational energy of the output shaft is stored as potential energy in the torsion spring. An electromechanical assembly is coupled to the ratchet assembly. The electromechanical assembly is configured to move the ratchet assembly from the engaged position to the disengaged position when the torsion spring reaches a pre-determined tightness, so that when the ratchet assembly is in the disengaged position, the torsion spring loosens and induces rotation of the output shaft in the second direction. A generator is coupled to the output shaft and is configured to convert rotational energy of the output shaft into electrical energy.

According to another broad aspect, an energy recovery system for converting vehicle motion into electrical power is provided. The energy recovery system comprises an arm mounted between a chassis of the vehicle and an axle of the vehicle. The arm is pivotably mounted at first and second opposed ends thereof and is configured to pivot with respect to the chassis and the axle when the chassis is vertically displaced with respect to the axle. A one-way ratchet assembly couples the arm to an output shaft. The ratchet assembly is movable between an engaged position and a disengaged position. In the engaged position, the ratchet assembly induces rotation of the output shaft in a first direction about a longitudinal axis thereof when the arm pivots in the first direction, and prevents rotation of the output shaft in a second direction opposite the first direction. In the disengaged position, the ratchet assembly does not prevent rotation of the output shaft in the second direction. A torsion spring is coupled to the output shaft such that when the output shaft is rotated in the first direction, the torsion spring is tightened and rotational energy of the output shaft is stored as potential energy in the torsion spring. An electromechanical assembly is coupled to the ratchet assembly. The electromechanical assembly is configured to move the ratchet assembly from the engaged position to the disengaged position when the torsion spring reaches a pre-determined tightness, so that when the ratchet assembly is in the disengaged position, the torsion spring loosens and induces rotation of a second output shaft. A generator is coupled to the second output shaft and is configured to convert rotational energy of the second output shaft into electrical energy.

### DRAWINGS

FIG. 1 is a partial rear view of a vehicle comprising two energy recovery systems;

FIG. 2 is a top plan view of one of the energy recovery systems of FIG. 1;

FIG. 3 is a partial perspective illustration of the energy recovery system of FIG. 2;

FIG. 4 is a partial perspective cutaway illustration of the energy recovery system of FIG. 2;

FIG. 5 is a partial perspective exploded and cutaway illustration of the energy recovery system of FIG. 2;

FIG. 6 is a partial cross section, taken along line 6-6 in FIG. 4;

FIG. 7A is a cross-section taken along line 7-7 in FIG. 4, showing a pawl assembly in an engaged position;

FIG. 7B is a cross-section taken along line 7-7 in FIG. 4, showing a pawl assembly in a disengaged position;

FIG. 8 is a perspective exploded illustration of a torsion spring, housing, and gear of the energy recovery system of FIG. 2;

FIG. 9A is a front plan view of the torsion spring and housing of FIG. 9B, showing the torsion spring in a first rotational position, with a second rotational position shown in dotted line;

FIG. 9B is a front plan view of the torsion spring and housing of FIG. 9B, showing the torsion spring in the second rotational position;

FIG. 10 is a partial perspective illustration of the energy recovery system of FIG. 2, showing a sliding arm positioned to disengaged a ratchet assembly; and

FIG. 11 is a partial perspective illustration of the energy recovery system of FIG. 2, showing a clutch assembly in a disengaged position.

### DESCRIPTION OF VARIOUS EMBODIMENTS

Various apparatuses or methods will be described below to provide an example of each claimed invention. No example described below limits any claimed invention and any claimed invention may cover processes or apparatuses that are not described below. The claimed inventions are not limited to apparatuses or processes having all of the features of any one apparatus or process described below or to features common to multiple or all of the apparatuses described below. It is possible that an apparatus or process described below is not an embodiment of any claimed invention. The inventor(s), applicant(s), and/or owner(s) maintain that rights to such features are not dedicated to the public as a result of being unclaimed in this application, and may be the subject matter of claims presented in other applications, such as, for example, continuation, continuation-in-part, divisional, or similar applications.

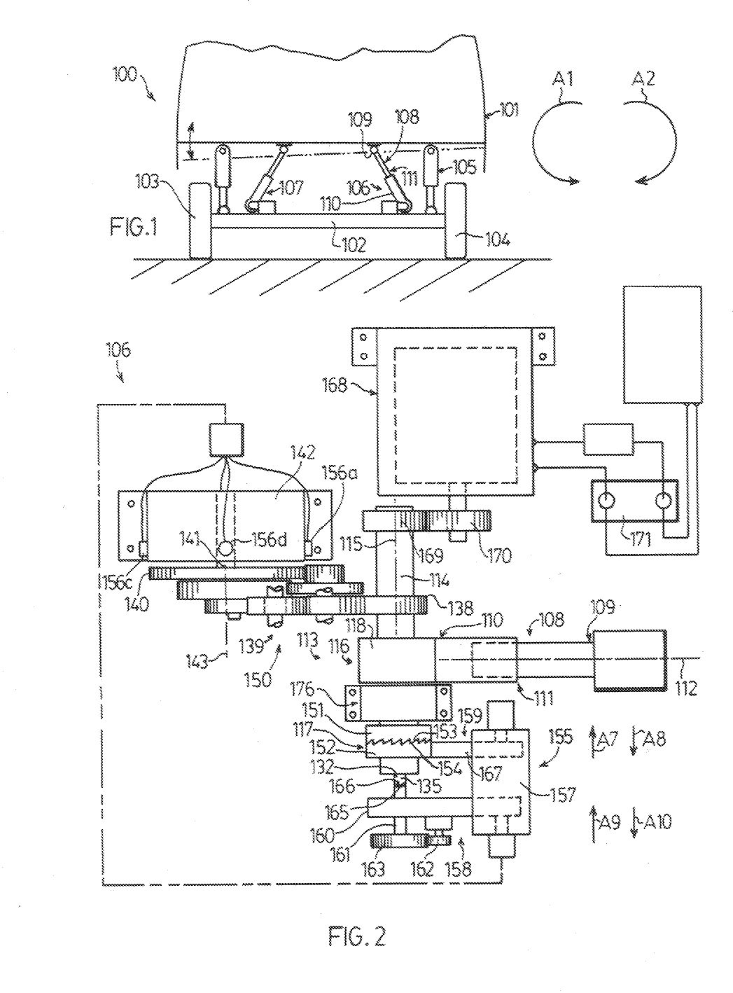

Referring to FIG. 1, a partial rear view of a vehicle 100 is shown. In the embodiment shown, the vehicle 100 is an automobile, and includes a chassis 101, a front axle (not shown), and a rear axle 102. Left 103 and right 104 wheels are mounted to the rear axle 102. The chassis is mounted to the front axle and the rear axle 102 by a suspension system 105. As is known in the art, when the automobile is in use, the suspension system allows for vertical movement of the chassis 101 with respect to front axle and the rear axle 102, in order to keep vehicle occupants comfortable and reasonably well isolated from road noise, bumps, and vibrations.

Referring still to FIG. 1, the vehicle 100 comprises an energy recovery system, which converts vehicle motion into electrical power. More particularly, the energy recovery system converts the vertical movement of the chassis 101 with respect to front axle and the rear axle 102 into electrical power. In the example shown, the vehicle 100 includes a first 106 and a second 107 energy recovery system. In alternate embodiments, the vehicle 100 may include only one energy recovery system, or more than two energy recovery systems. For example, as shown, the vehicle includes the first 106 and the second 107 energy recovery system, both of which are mounted to the rear axle 102. In alternate examples, the vehicle may also include a third and a fourth energy recovery system, which are mounted to the front axle. Alternately, the vehicle may include one energy recovery system on each axle.

In the embodiment shown, the first 106 and second 107 energy recovery systems are substantially identical. As such, a description will be provided of only the first energy recovery system.

Referring to FIGS. 1 to 3, the energy recovery system 106 comprises a pivoting arm 108 mounted between the chassis 101 of the vehicle 100 and the axle 102 of the vehicle 100. The arm 108 is configured to pivot with respect to the chassis 101 and the axle 102 when the chassis 101 is vertically displaced with respect to the axle 102. Specifically, in the embodiment shown, the arm has a first end 109, an opposed second end 110, and a body portion 111 extending therebetween along a longitudinal axis 112. The first end 109 of the arm 108 is pivotally mounted directly to chassis 101. For example, as shown in FIG. 3, a shackle 172 is mounted to the chassis. A clevis pin 173 is inserted through the arms of the shackle 172. The first end 109 of the arm comprises a cylinder 173, which is received on and pivots about the clevis pin 173. The second end 110 of the arm is pivotally mounted to the axle 102. Specifically, in the embodiment shown, a bracket 176 is provided, which is mounted to the axle 102, and which is coupled to the second end 110 of the arm 108 via an output shaft 114 and cylinder 118, as will be described further hereinbelow.

In an alternate embodiment (not shown), the first end 109 of the arm 108 may be pivotally mounted to the chassis 101 indirectly. For example, the first end 109 of the arm 108 may be pivotally mounted to a portion of the suspension system 105. In a further alternate embodiment (not shown), the arm 108 may be a part of the suspension system.

When the axle 102 moves towards the chassis 101, the distance between the first end 109 of the arm 108 and the second end 110 of the arm 108 can shorten. The body 11 of the arm 108 can be telescopic, to facilitate pivoting of the arm 108 relative to the chassis 101 and the axle 102 in cases where the distance between the ends of the arm lengthens and shortens during operation.

When the axle 102 moves towards the chassis 101, the arm pivots at both ends thereof, such that the body portion rotates in a first direction, indicated by arrow A1 in FIG. 1. Specifically, in the embodiment shown, the body portion rotates towards a horizontal positioning. When the axle 102 moves away the chassis 101, the arm pivots at both ends thereof, such that the body portion rotates in a second direction, indicated by arrow A2, opposite the first direction. Specifically, in the embodiment shown, the body portion rotates towards a vertical positioning. Accordingly, when the vehicle is in use, for example being driven along a road, the arm 108 will repeatedly rotate back and forth, as the axle moves towards and away from the chassis in cooperation with the vehicle suspension system.

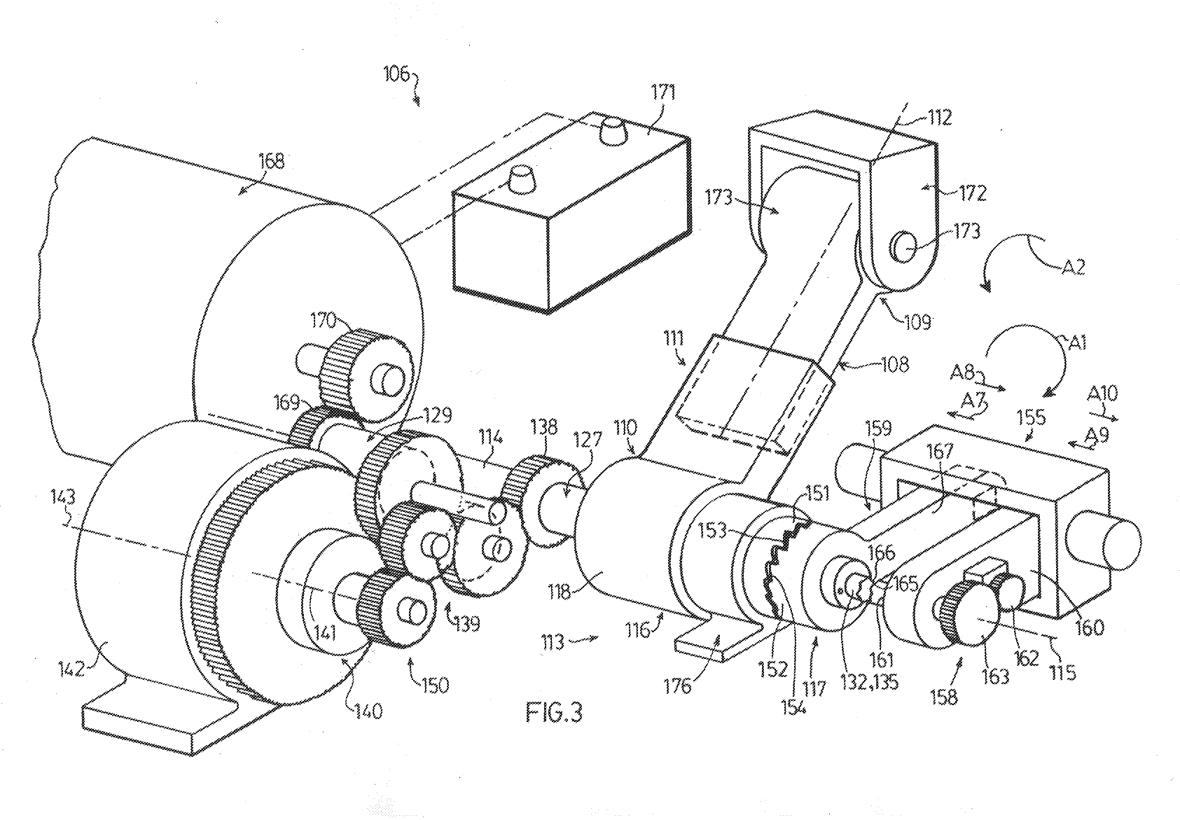

Referring now to FIGS. 2 to 4, an output shaft 114 is provided. The output shaft 114 extends along a longitudinal axis 115, which, in the embodiment shown, is generally perpendicular to the longitudinal axis 112 of the arm 108. The output shaft has a first end portion 125, a central portion 127, and a second end portion 129 opposed to the first end portion 125.

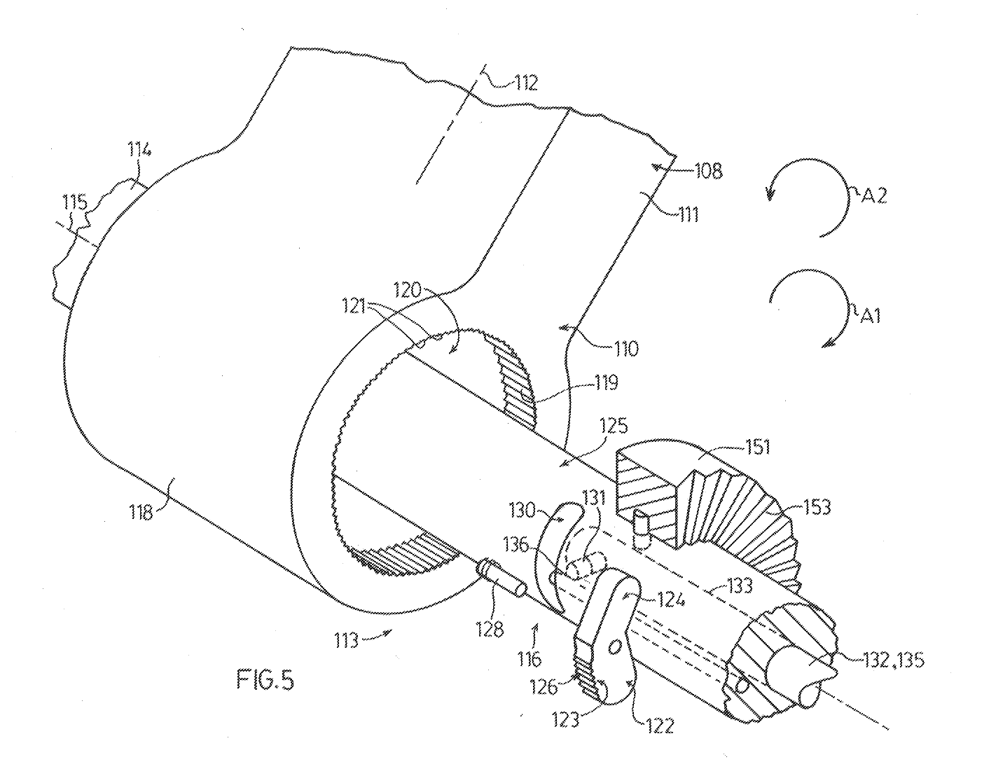

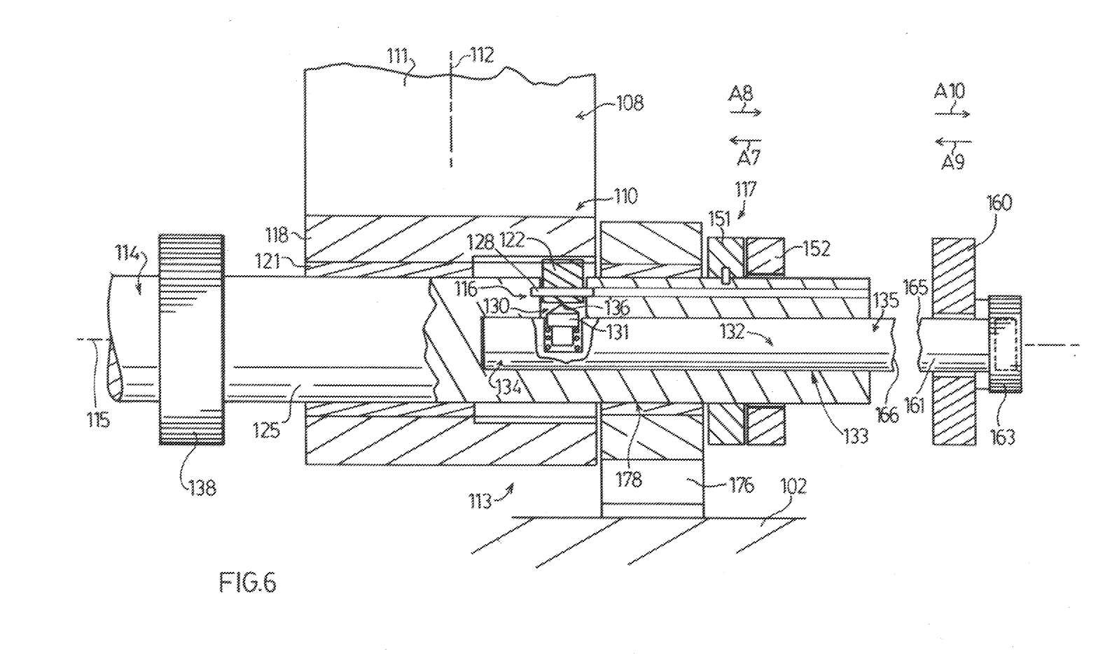

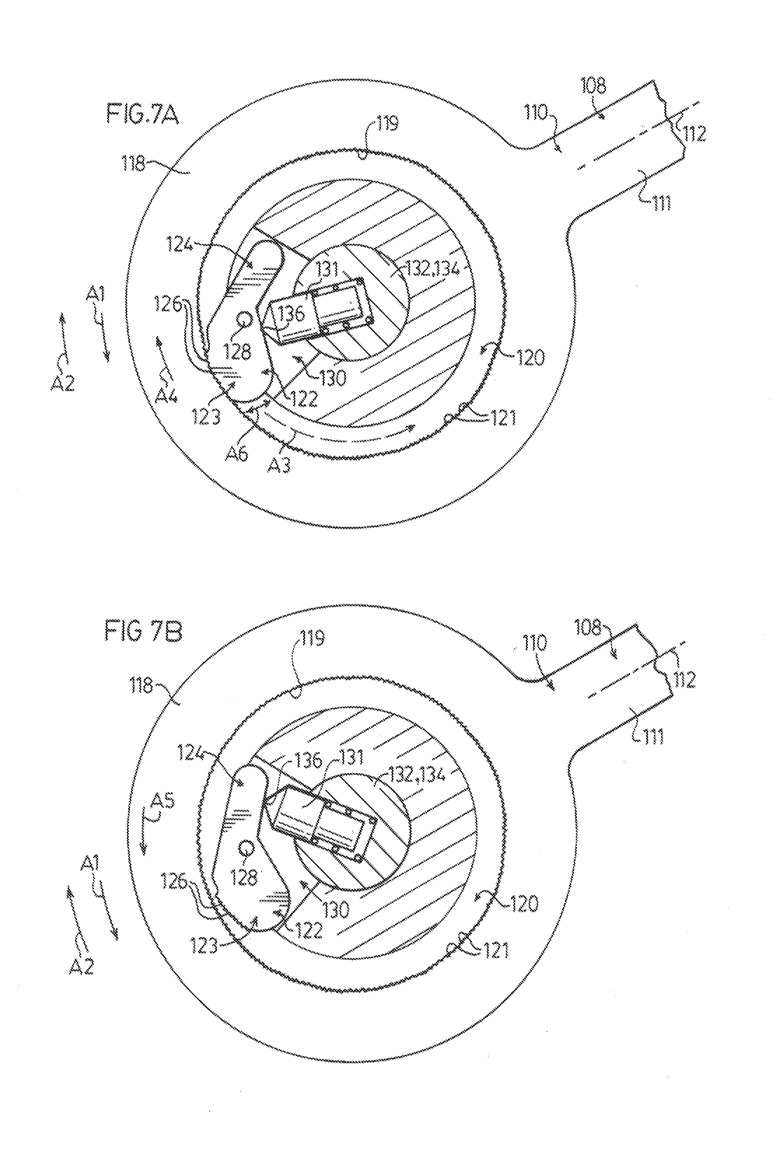

Referring to FIGS. 2 to 7, a one-way ratchet assembly 113 couples the arm 108 to the output shaft 114. The one-way ratchet assembly 113 is configured to transfer the pivoting motion of the arm 108 into rotational motion of the output shaft 114. Particularly, the one-way ratchet assembly 113 is movable between an engaged position, shown in FIG. 7A, and a disengaged position, shown in FIG. 7B. When the ratchet assembly 113 is in the engaged position, it serves to (1) induce rotation of the output shaft 114 about axis 115 in the first direction (i.e in the direction indicated by arrow A1) when the arm 108 pivots in the first direction; and (2) prevent rotation of the output shaft 114 about axis 115 in the second direction (i.e. the direction indicated by arrow A2). When the ratchet assembly 113 is in the disengaged position, it does not prevent rotation of the output shaft 114 about the axis 115 in the second direction. For example, when the ratchet assembly 113 is in the engaged position, if the axle 102 moves towards the chassis 101 so that the arm 108 rotates in the direction indicated by arrow A1, the ratchet assembly 113 induces rotation of the output shaft 114 about axis 115 in the direction indicated by arrow A1. Further, at other times, for example when the axle 102 moves away from the chassis 101 so that the arm 108 pivots in the direction indicated by arrow A2, or if the arm 108 is stationary, the ratchet assembly 113 prevents rotation of the output shaft 114 about axis 115 in the direction indicated by arrow A2. When the ratchet assembly 113 is in the disengaged position, rotation of the output shaft 114 about axis 115 in the second direction in the direction indicated by arrow A2 is not prevented. Accordingly, if an external force acts upon the output shaft 114 when the ratchet assembly is in the disengaged position, for example the force exerted by a torsion spring 137 as will be described further hereinbelow, the output shaft 114 may rotate in the second direction (as indicated by arrow A2) about axis 115.

Referring still to FIGS. 2 to 7, in the example shown, the ratchet assembly 113 comprises a pawl assembly 116, and a clutch assembly 117. The pawl assembly 116 serves to induce the rotation of the output shaft 114 about axis 115 in the first direction when the arm 108 pivots in the first direction. The clutch assembly 117 serves to prevent the rotation of the output shaft 114 about axis 115 in the second direction.

Specifically, in the example shown, the pawl assembly 116 is movable between a pawl assembly engaged position and a pawl assembly disengaged position, and the clutch assembly 117 is movable between a clutch assembly engaged position and a clutch assembly disengaged position. When the pawl assembly 116 is in the pawl assembly engaged position, it induces the rotation of the output shaft 114 in the first direction when the arm 108 pivots in the first direction. When the clutch assembly 117 is in the clutch assembly engaged position, it prevents the rotation of the output shaft 114 about axis 115 in the second direction. Accordingly, when both the pawl assembly 116 and the clutch assembly 117 are in the engaged position, the ratchet assembly 113 is in the engaged position.

Referring still to FIGS. 2 to 7, in the embodiment shown, the pawl assembly 116 comprises a cylinder 118. The cylinder 118 extends collinear to the output shaft 114 (i.e. extends along axis 115), and perpendicular to the arm 108 (i.e. perpendicular to axis 112). The cylinder 118 is coupled to the arm 108 such that it is fixedly positioned with respect to the second end 110 of the arm 108. Specifically, in the embodiment shown, the cylinder 118 is integral with the arm 108. Accordingly, when axle 102 moves up and down with respect to the chassis 101 and the arm 108 rotates back and forth in the first direction and the second direction, the cylinder 118 rotates back and forth in the first direction and the second direction about axis 115. For example, when the arm 108 rotates in the first direction, the cylinder 118 will rotate in the first direction about axis 115.

The cylinder 118 has a bore 120 extending longitudinally therethrough, along axis 115. The second end portion 127 of the output shaft 114 is received in the bore 120 of the cylinder 118, and in a bore 178 of the bracket 176. As mentioned hereinabove, this configuration pivotally mounts the second end 110 of the arm to the axle 102.

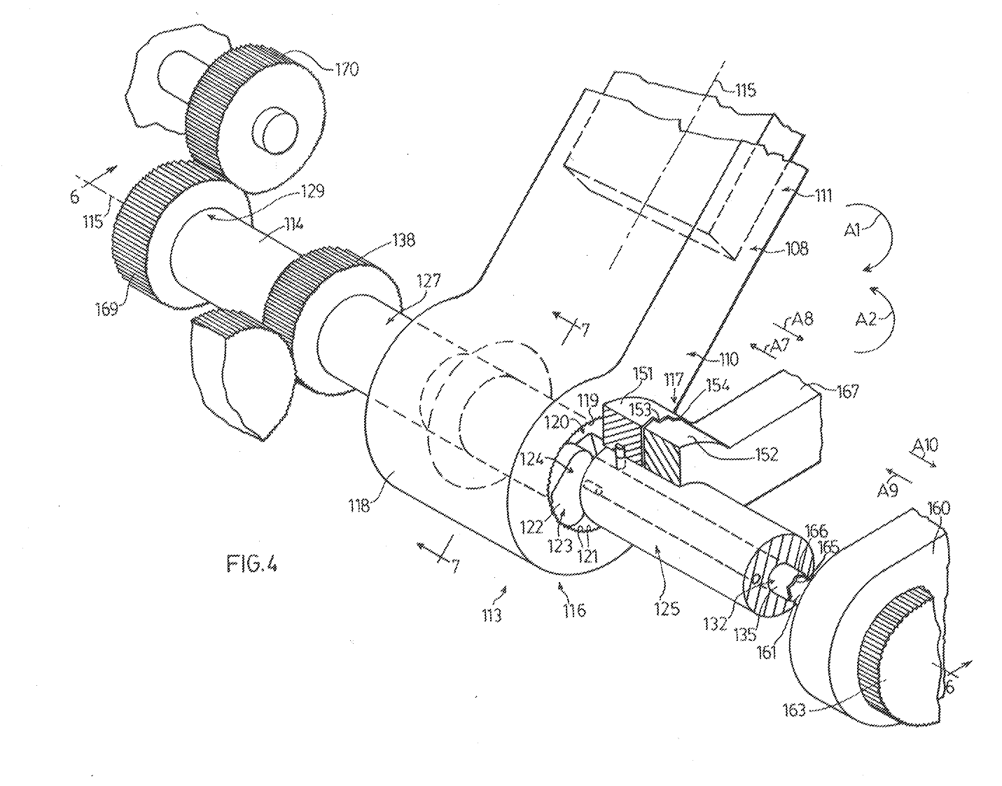

The bore 120 is defined by an inner surface 119 of the cylinder 118. The inner surface 119 comprises a plurality of teeth 121, which extend inwardly towards the axis 115, and extend parallel to the axis 115. Accordingly, the bore 120 may be referred to as toothed bore 120. Referring to FIGS. 4 to 7, the pawl assembly 116 further comprises a toothed pawl 122 received within the toothed bore 120, and coupled to the output shaft 114. As shown most clearly in FIG. 7A, when the pawl assembly 116 is in the pawl assembly engaged position, the toothed pawl 122 engages the toothed bore 120. When the toothed pawl 122 engages the toothed bore 122, rotation of the cylinder 118 in the first direction induces orbital rotation of the toothed pawl 122 in the first direction about the longitudinal axis 115 of the cylinder 118. The path of the orbital rotation of the toothed pawl 122 is indicated by arrow A3 in FIG. 7A. As will be described in further detail hereinbelow, the toothed pawl 122 is coupled to the output shaft 114 such that the orbital rotation of the toothed pawl 122 in the first direction induces the rotation of the output shaft 114 in the first direction. Further, when the toothed pawl 122 engages the toothed bore 122, rotation of the cylinder 118 in the second direction does not induce orbital rotation of the toothed pawl 122 in the second direction about the longitudinal axis 115 of the cylinder 118. When the pawl assembly 116 is in the pawl assembly disengaged position, the toothed pawl 122 does not engage the toothed bore 120, and rotation of the cylinder 118 in the first direction does not induce orbital rotation of the toothed pawl 122 in the first direction about the longitudinal axis 115 of the cylinder 118.

Referring still to FIGS. 4 to 7B, in the embodiment shown, the toothed pawl 122 has a first portion 123, and a second portion 124. The first portion 123 has a plurality of teeth 126 positioned in facing relation to the teeth 121 of the bore 120. The second portion 124 does not have any teeth. The pawl assembly 116 further comprises a pivot pin 128, about which the toothed pawl 122 is pivotal, which extends parallel to axis 115, and which is mounted to the output shaft 114 to couple the toothed pawl 122 to the output shaft 114. Specifically, the first end portion 125 of the output shaft 114 has a recess 130 defined therein, extending inwardly towards axis 115 from the outer surface of the output shaft 114. The pawl 122 is partially received in the recess 130, and the pivot pin 128 extends across the recess 130 and through the pawl 122, to mount the pawl 122 to the output shaft 114.

The pawl 122 is pivotal about the pivot pin 128 between a first pivotal position, shown in FIG. 7A, and a second pivotal position, shown in FIG. 7B. A spring 174 is provided, which biases the pawl 122 to the first pivotal position. When the pawl assembly 116 is in the pawl assembly engaged position, the toothed pawl 122 is pivoted to the first pivotal position, so that the teeth of the first portion 123 of the pawl 122 engage the teeth 121 of the cylinder 118, and toothed pawl 122 thereby engages the toothed bore 120. When the pawl assembly 116 is in the pawl assembly disengaged position, the toothed pawl 122 is pivoted to the second pivotal position, shown in FIG. 7B, so that the teeth of the first portion of the pawl do not engage the teeth of the cylinder, and the toothed pawl therefore does not engage the toothed bore.

In order to move the pawl 122 between the first pivotal position and the second pivotal position, a plunger 131 and control shaft 132 are provided. The control shaft 132 extends collinear to the output shaft 114, and has a first end portion 134, and an opposed second end portion 135. The output shaft 114 has a bore 133 defined therein, which extends along axis 115 and is in communication with recess 130. The first end portion 134 of the control shaft 132 is received in the bore 133. The plunger 131 is mounted to the first end portion 134 of the control shaft 132, and extends outwardly therefrom and into the recess 128, such that a distal end 136 of the plunger 131 contacts the pawl 122. A spring 137 is provided, which biases the plunger 131 to bear against the pawl 122. In order to move the toothed pawl 122 from the first pivotal position to the second pivotal position, the control shaft 132 is rotated about axis 115 in a direction indicated by arrow A4 in FIG. 7A, which moves the plunger 131 between a first angular position, shown in FIG. 7A, and a second angular position, with respect to the toothed pawl 122, shown in FIG. 7B. When the plunger 131 is in the first angular position, the plunger 131 bears against the first portion 123 of the pawl 122, forcing the first portion 123 to pivot towards the cylinder 118, and forcing the teeth 126 of the pawl 122 to engage the teeth 121 of the cylinder 118. In order to move the toothed pawl 122 from the second pivotal position to the first pivotal position, the control shaft 132 is rotated about axis 115 in a direction indicated by arrow A5, which moves the plunger 131 between the first angular position, shown in FIG. 7A, and the second angular position, shown in FIG. 7B. When the plunger 131 is in the second angular position, the plunger 131 bears against the second portion 124 of the pawl, forcing the first portion 123 to pivot away from the cylinder 118, and forcing the teeth 126 of the pawl 122 to retract and disengage from the teeth 121 of the cylinder 118.

The rotation of the control shaft is controlled by an electromechanical assembly 155, and will be described in further detail hereinbelow.

Referring still to FIGS. 7A and 7B, when the plunger 131 is in the first angular position and bears against the first portion 123 of the pawl 122 to force the teeth 126 of the pawl 122 to engage the teeth 121 of the cylinder 118, rotation of the cylinder 118 in the first direction will induce orbital rotation of the toothed pawl 122 in the first direction about the longitudinal axis 115 of the cylinder 118. As the plunger 131 bears against the toothed pawl 122 and is mounted to the control shaft 132, the plunger 131 and control shaft 132 will rotate together with the toothed pawl 122 about the axis 115. Further, when the teeth 126 of the pawl 122 engage the teeth 121 of the cylinder 118, rotation of the cylinder 118 in the second direction will not induce orbital rotation of the toothed pawl 122 in the second direction about the longitudinal axis 115 of the cylinder 118. Rather, when the cylinder 118 rotates in the second direction, the pawl 122 will ratchet (i.e. the pawl 122 will vibrate back and forth in a direction indicated by arrow A6).

Accordingly, as the arm 108 repeatedly rotates back and forth in the first direction and the second direction, the cylinder 118 will repeatedly rotate back and forth in the first direction and the second direction about axis 115. When the pawl assembly 116 is in the pawl assembly engaged position, the rotation of the cylinder 118 in the first direction will induce orbital rotation of the toothed pawl 122 about axis 115 in the first direction (as shown by arrow A3). As the toothed pawl 122 is mounted to the output shaft 114 by the pivot pin 128, the orbital rotation of the toothed pawl 122 will induce orbital rotation of the pivot pin 128 about axis 115, which will in turn induce rotation of the output shaft 114 about axis 115 (i.e. the orbital rotation of the toothed pawl 122 in the first direction induces the rotation of the output shaft 114 in the first direction via the pivot pin 128). Due to the configuration of the pawl assembly 116, the rotation of the cylinder 118 in the second direction will not induce orbital rotation of the toothed pawl 122 in the second direction. Therefore, as the arm 108 repeatedly rotates back and forth, the output shaft 114 will rotate in only the first direction.

Referring now to FIGS. 2, 3, and 8-9B, a torsion spring 137 is coupled to the output shaft 114. The torsion spring 137 is coupled to the output shaft 114 such that when the output shaft 114 is rotated in the first direction, the torsion spring 137 is tightened. Accordingly, the rotational energy of the output shaft 114 is stored as potential energy in the torsion spring 137.

In the embodiment shown, the output shaft 114 is coupled to the torsion spring 137 by a series of gears 150. Specifically, in the embodiment shown, a first gear 138 is mounted around the output shaft 114. A plurality of additional gears 139 is provided between the first gear 138 and the torsion spring 137. Specifically, in the embodiment shown, the additional gears include a second gear 180 driven by the first gear 138, a third gear 181 driven by the second gear, and a fourth gear 182 driven by the third gear 181. Further, a fifth gear 183 (shown in dotted line) is mounted on the same gear shaft as the second gear 180, a sixth gear 184 is driven by the fifth gear 183, and a seventh gear 185 (shown in dotted line) is mounted on the same gear shaft as the sixth gear 184. The seventh gear 185 drives an eighth gear 186. The fourth gear 182 and the eighth gear 183 are mounted on the same gear shaft 141, which, as will be described hereinbelow, is coupled to the torsion spring 137. This configuration of gears serves to provide control to the system 100, and to maximize the energy output of the system 100. In alternate embodiments, however, an alternate configuration of gears, or only one gear may be provided.

In some embodiments (not shown), some of the gears 150 may be translatably mounted. For example, the gear shaft of the third gear 181 may be mounted such that the third gear 181 may move (with its shaft and orthogonally relative to its axis) slightly away from the fourth gear 182 in a vertical direction, so that the teeth of the third 181 and fourth 182 gear no longer engage. The second gear 180 may also be movably mounted, to accommodate the movement of the third gear 181. When the spring 137 unwinds, as will be described hereinbelow, it causes the fourth 182 gear to rotate, which causes the third gear to rotate, which causes the second gear 180 to rotate, which causes the first gear 138 to rotate. The rotation of the first gear 138 causes the output shaft 114 to rotate in the second direction. When the spring has finished unwinding, the fourth gear 182 will generally cease to rotate. The third gear can move slightly away from the fourth gear 182, and can (due to, for example its momentum), continue to rotate even after the spring has stopped unwinding. This will cause the second gear 180 and first gear 130, and therefore the output shaft 114, to continue rotating even after the spring 137 has stopped unwinding. This may further serve to maximize the energy output of the system.

The torsion spring 137 has a first or inner end 144, and a second or outer end 145, and extends along a spring axis 143. The second end 145 of the torsion spring is releasably fixed in position. For example, as shown, the torsion spring 137 is received in a housing 142. The housing 142 comprises a catch 146a on an inner surface 147 thereof, and the outer end 145 of the spring 137 is releasably secured to the catch 146a. In the example shown, the catch 146a is a recess formed in the inner surface 147 of the housing 142, and the second end 145 of the spring 137 comprises a protrusion 149 that is received in the recess and frictionally held therein. The inner end 144 of the spring 137 is coupled to the gear shaft 141, which extends along the spring axis 143. Accordingly, when the output shaft 114 rotates in the first direction, and the gears 150 rotate, the first end 144 of the spring 137 is wound about the spring axis 143, in a direction indicated by arrow A12, and the spring 137 is tightened.

Referring back to FIGS. 2-4, as the spring 137 is tightened, the elastic properties of the spring 137 will tend to oppose the tightening force to cause the spring 137 to unwind. For example, in use, if the arm 108 pivots in the first direction and the pawl assembly 116 is engaged, the pawl assembly 116 will cause the output shaft 114 to rotate, and the spring 137 will be tightened. If the arm 108 subsequently becomes stationary, and therefore the output shaft 114 becomes stationary, the spring 137 will tend to unwind, and due to its coupling to the output shaft 114, will tend to cause the output shaft 114 to rotate in the second direction. Accordingly, the clutch assembly 117 is provided, which, as mentioned hereinabove, prevents rotation of the output shaft 114 in the second direction, and as such, prevents unwinding of the spring 137.

Referring still to FIGS. 2 to 4 and 11, the clutch assembly 117 comprises a first bracket 151 and a second bracket 152. The first bracket is fixedly mounted to the first end portion 125 of the output shaft 114, so that rotation of the output shaft 114 in both the first direction and the second direction induces rotation of the first toothed bracket 151. Specifically, in the embodiment shown, the first bracket 151 is annular, and is received on and fixedly mounted to the first end portion 125 of the output shaft 114. The second bracket 152 is rotationally fixed with respect to the output shaft 114. That is, the second bracket 152 is not rotatable, regardless of any rotation of the output shaft 114.

The first bracket 151 comprises a first toothed surface 153, and the second bracket 152 comprises a second toothed surface 154. The first toothed surface 153 and the second toothed surface 154 are positioned in facing relation to each other. When the clutch assembly 117 is in the clutch assembly engaged position, the second bracket 152 is moved towards the first bracket 151, in a direction indicated by arrow A7, so that the second toothed surface 154 moves towards the first toothed surface 153 and contacts and engages the first toothed surface 153. The teeth on the first toothed surface 153 and the second toothed surface 154 are configured such that when the first 153 and second 154 toothed surfaces are engaged, the first bracket 151 may rotate in the first direction with respect to the second bracket 152; however, the first bracket 151 may not rotate in the second direction with respect to the second bracket 152. Particularly, the teeth on the first toothed surface 153 and the second toothed surface 155 are angled in opposite directions, so that rotational motion of the first bracket 151 with respect to the second bracket 152 may only occur in the first direction.

Accordingly, when the clutch assembly 117 is in the clutch assembly engaged position, rotation of the first bracket 151 in the second direction is prevented. As the first bracket 151 is fixedly mounted to the output shaft 114, rotation of the output shaft 114 in the second direction is prevented, and as such, unwinding of the spring 137 is prevented.

When the clutch assembly is in the clutch assembly disengaged position, as shown in FIG. 11, the second bracket 152 is moved away from the first bracket 151, in a direction indicated by arrow A8, so that the first toothed surface 153 and the second toothed surface 154 become disengaged. The movement of the second bracket 152 will be described further hereinbelow. Accordingly, when the clutch assembly is in the clutch assembly disengaged position, rotation of the output shaft 114 in the second direction is not prevented, and as such, unwinding of the spring 137 is not prevented.

Accordingly, when the ratchet assembly 113 is in the engaged position, and as the arm 108 repeatedly pivots back and forth, the ratchet assembly 113 will rotate the output shaft 114 in the first direction, which will induce tightening of the torsion spring 137. Referring now to FIGS. 2-4 and 8-11, the system 100 is configured such that when the spring 137 reaches a predetermined tightness, the ratchet assembly 113 moves from the engaged position to the disengaged position, so that the torsion spring 137 unwinds or loosens and induces rotation of the output shaft 114 in the second direction.

Specifically, in the example shown, an electromechanical assembly 155 is provided, which is coupled to the ratchet assembly 113. The electromechanical assembly 155 is configured to move the ratchet assembly 133 from the engaged position to the disengaged position when the torsion spring 137 reaches the pre-determined tightness.

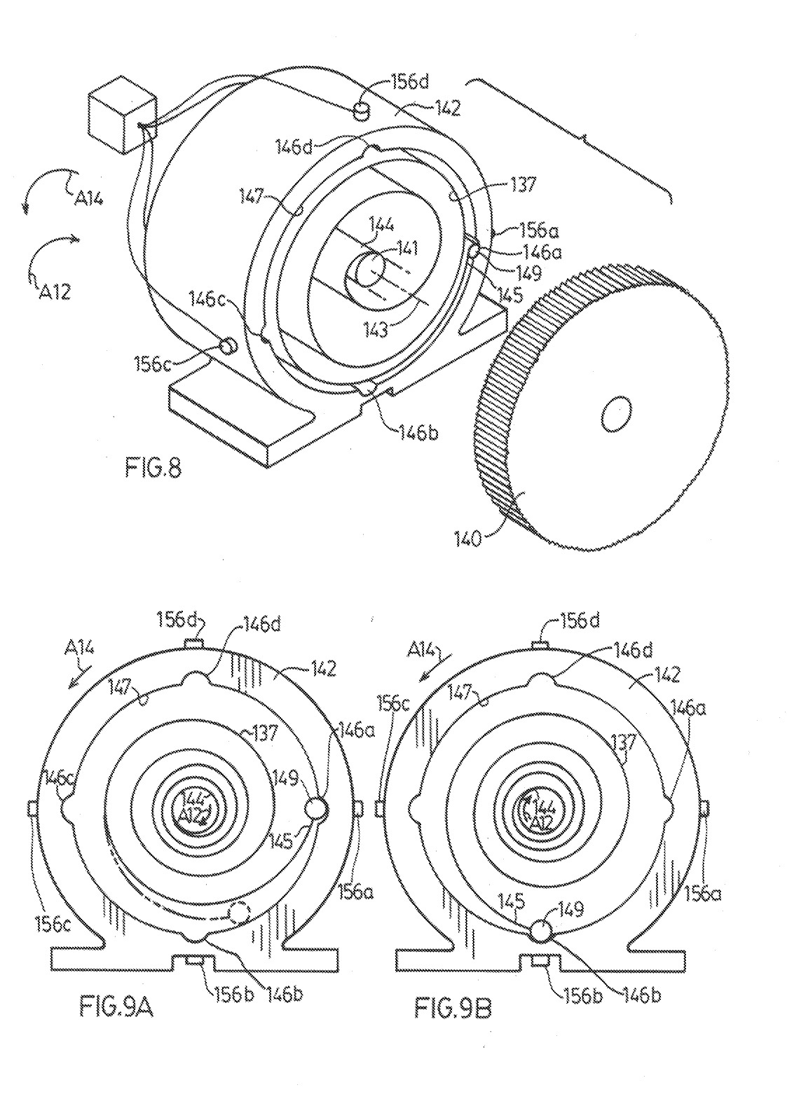

Referring again to FIGS. 8 to 9B, the electromechanical assembly 155 is connected to a plurality of sensors 156a-156d, which sense tightness of the spring 137. Specifically, as mentioned hereinabove, the second end 145 of the spring 137 is releasably secured to catch 146a, and the first end of the spring is wound about the spring axis. In the embodiment shown, a plurality of catches 146a-d are provided, and are positioned around the perimeter of the inner surface 147 of the housing 142. As the spring 137 is wound, the force required to continue winding the spring will eventually become greater than the force required to maintain the second end 145 of the spring 137 secured to the catch 146. When this occurs, the predetermined tightness has been reached, and the second end 145 of the spring 137 will snap out of the catch 146. The rotation of the gear shaft 141 will cease to cause tightening of the spring 137, and instead will cause the entire spring 137 to rotate about the spring axis 143. As the entire spring 137 rotates, the second end 145 of the spring 137 will snap into an adjacent catch, as shown in FIGS. 9A and 9B.

The sensors 156a-156d may be configured to sense the tightness of the spring 137 by sensing any of when the second end 145 of the spring 137 is released from the catch 145a, when the spring 137 rotates about the spring axis 143, and/or when the second end 145 of the spring 137 snaps into an adjacent catch. In the embodiment shown, the sensors 156a-156d are configured to sense when the second end 145 of the spring 137 snaps into an adjacent catch. Particularly, the sensors 156a to 156d are each provided on one of the catches 146a-146d. The sensors 156a-d may be pressure sensors for example, which sense when the second end 145 of the spring 137 snaps into the catch associated therewith. The sensors 156a-156d are in communication with the electromechanical assembly 155, and send a signal to the electromechanical assembly 155 when any of the sensors 156a-156d are triggered. This triggers the electromechanical assembly 155 to move the ratchet assembly 113 to the disengaged position.

Referring to FIGS. 2, 3, 10, and 11, in order to move the ratchet assembly 113 from the engaged position to the disengaged position, the electromechanical assembly 155 comprises a control unit 157, a pawl assembly actuation unit 158, and a clutch assembly actuation unit 159. The control unit 157 receives signals from the sensors 155a-155d, and controls the pawl assembly actuation unit 158, and a clutch assembly actuation unit 159.

Referring to FIGS. 2, 3, and 10, the pawl assembly actuation unit 158 comprises a first sliding arm 160, which may be slid back and forth in a direction indicated by arrows A9 and A10 by the control unit 157. A shaft 161 is coupled to the first sliding arm 160, and extends transversely to the first sliding arm 160 and collinear to axis 115. The shaft 161 is rotatably mounted to the first sliding arm 160 (i.e. it may be rotated with respect to the first sliding arm 160) about axis 115. Further, the shaft 161 has a toothed end face 165. A first gear 162 is mounted to the first sliding arm 160, and a second gear 163 is mounted to the shaft 161. The second gear 163 is fixedly mounted to the shaft 161, such that rotation of the second gear 163 induces rotation of the shaft 161 about axis 115. The first gear 162 is coupled to the second gear 163 such that rotation of the first gear 162 induces rotation of the second gear 163. The rotation of first gear 162 is controlled by the control unit 157.

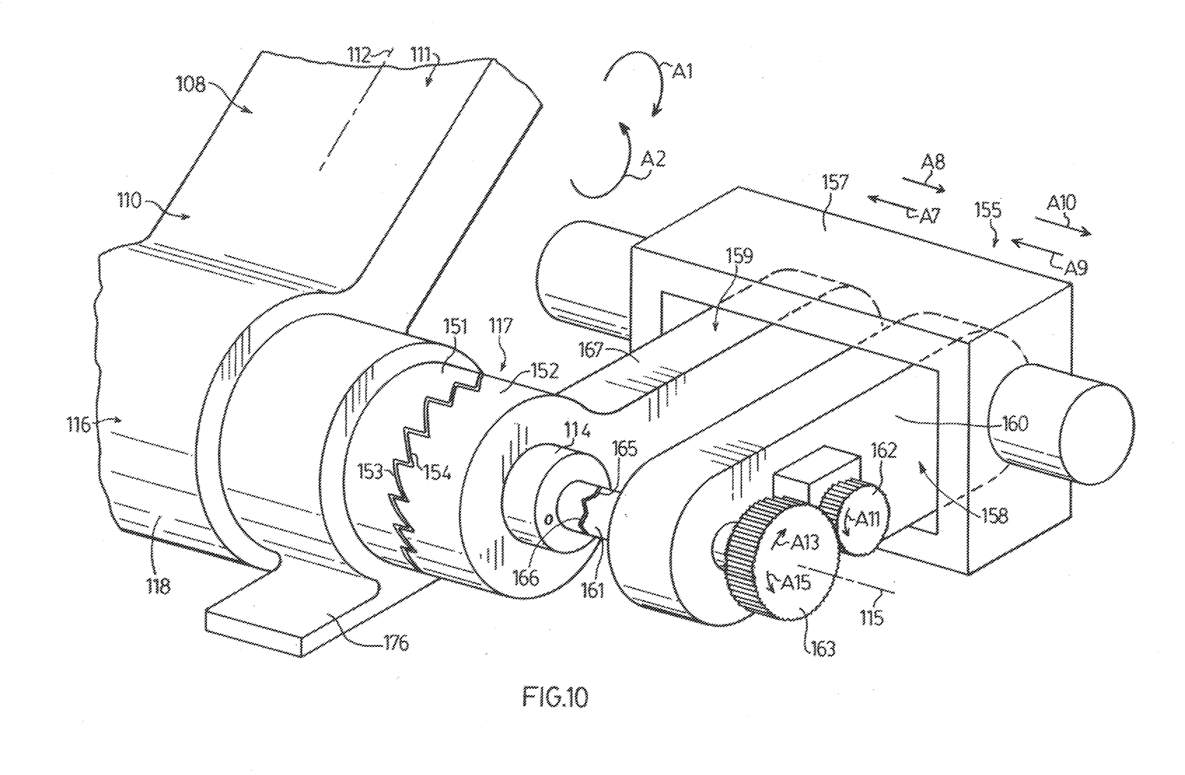

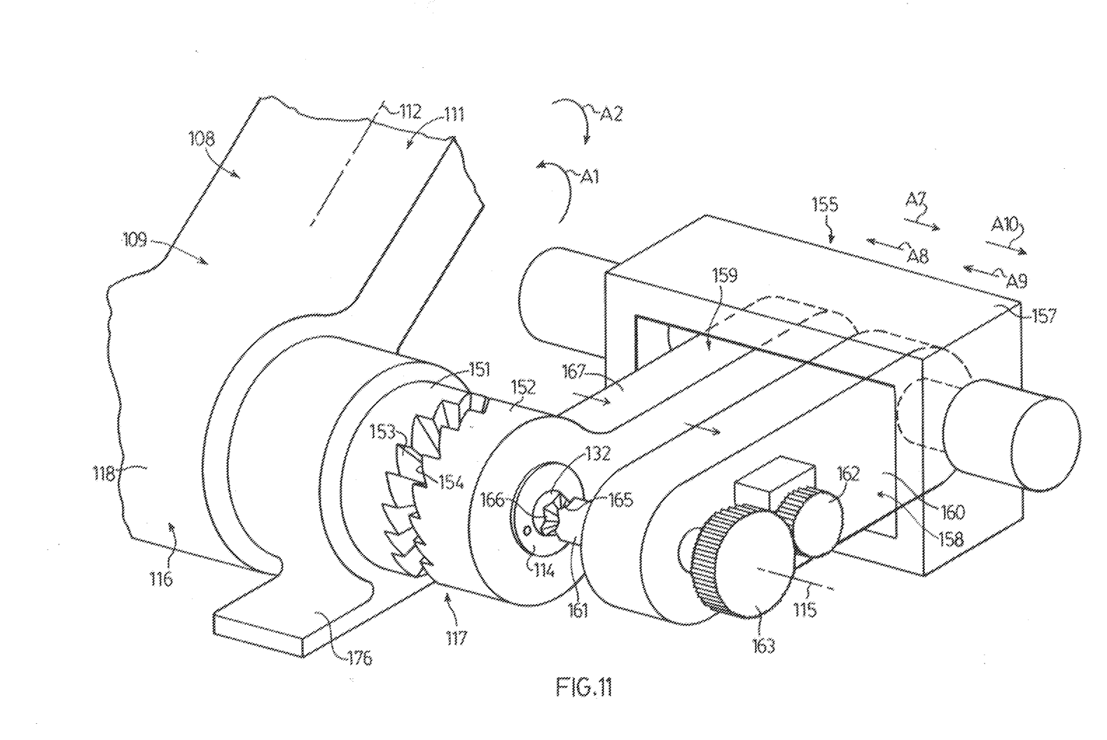

Referring still to FIG. 2, 3 and 10, the second end portion 135 of the control shaft 132 has a toothed end face 166, which is positioned in facing relation to the toothed end face 165 of the shaft 161. When the control unit 157 receives a signal from the sensors 156a-156d, the control unit 157 moves the first sliding arm 160 in a direction indicated by arrow A9, which moves the shaft 161 in the direction indicated by arrow A9, so that the toothed end face 165 of the shaft 161 contacts and engages the toothed end face 166 of the control shaft 132, as shown in FIG. 10. The control unit 157 then rotates the first gear 162 in a direction indicated by arrow A11, which rotates the second gear 163, and in turn the shaft 161, in a direction indicated by arrow A13. The toothed end face 165 of the shaft 161 engages the toothed end face 166 of the control shaft 132, and causes the control shaft 132 to rotate in the about axis 115 in a direction indicated by arrow A4 in FIG. 7A. This moves the plunger 131 from the first angular position, shown in FIG. 7A, to the second angular position, shown in FIG. 7B. As mentioned hereinabove, plunger 131 bears against the toothed pawl 122, and movement of the plunger 131 to the second angular position moves the toothed pawl 122 to the second pivotal position. In the second pivotal position, the toothed pawl 122 no longer engages the cylinder 118, and the pawl assembly 116 is in the disengaged position. As such the rotation of the arm 108 will no longer induce the orbital rotation of the toothed pawl 122 about the axis 115, and the toothed pawl 122 will no longer induce the rotation of the output shaft 114 about axis 115.

After the shaft 161 has been turned in the direction indicated by arrow A13, the control unit 157 moves the first sliding arm 160 in the direction indicated by arrow A10, to withdraw the toothed end face 165 of the shaft 161 from the control shaft 132.

Referring to FIGS. 2, 3 and 11, the clutch assembly actuation unit 159 comprises a second sliding arm 167. The second sliding arm 167 is mounted to the second bracket 152, and extends transversely to axis 115. When the control unit 157 receives a signal from the sensors 156a-156d, and after the control unit 157 moves the pawl assembly 116 to the pawl assembly disengaged position, the control unit 157 moves the second sliding arm 167 in a direction indicated by arrow A8, which moves the second bracket 152 in the direction indicated by arrow A8, away from the first bracket 151, so that the first toothed surface 153 and the second toothed surface 154 become disengaged, and the clutch assembly 117 is in the clutch assembly disengaged position, as shown in FIG. 11.

When the pawl assembly 116 is in the pawl assembly disengaged position, and the clutch assembly 117 is in the clutch assembly disengaged position, the ratchet assembly 113 is in the disengaged position. When the ratchet assembly 113 is in the disengaged position, rotation of the output shaft 114 in the second direction is no longer prevented, and unwinding of the torsion spring 137 is no longer prevented. As such, the torsion spring 137 loosens or unwinds. The loosening of the torsion spring 137 induces the rotation of the output shaft 114 in the second direction. Specifically, referring to FIGS. 8 to 9B, in the embodiment shown, the inner end 144 of the torsion spring 137 unwinds in a direction indicated by arrow A14 about the spring axis 134. This causes the gear shaft 141 to rotate in a direction indicated by arrow A14, which rotates the gears 150, which rotate the output shaft 114 in the second direction.

Referring again to FIGS. 2-4, a generator 168 is coupled to the output shaft 114. The generator 168 may be any suitable generator, such as a dynamo comprising a rotor (not shown) and a stator (not shown), and is configured to convert the rotational energy of the output shaft 114 into electrical energy. Specifically, the output shaft 114 is coupled to the generator, such that when the output shaft 114 rotates in the second direction, the rotational energy the output shaft 114 is transferred to the rotor of the generator 168. As shown, the second end portion 129 of the output shaft 114 is fixedly coupled to an output gear 169, which is rotationally coupled to a generator gear 170. When the output shaft 114 rotates in the second direction, the output gear 169 rotates, which induces rotation of the generator gear. The generator gear 170 is coupled to the rotor of the generator 168, so that rotation of the generator gear 170 causes the generator to generate electrical energy.

A battery 171 is coupled to the generator 168, and is configured to store the electrical energy generated by the generator 168. The battery may be used to power various systems in the vehicle 100. For example, if the vehicle 100 is an electric automobile, the battery may power the motor of the automobile. Alternately, the battery may power any of the starter motor, the lights, or the ignition system of the vehicle 100. Alternately, some or all of the energy stored in the battery may be fed to an external electrical grid.

While the spring is unwinding, the arm 108 will continue to rotate back and forth as the chassis 101 moves towards and away from the axle 102. However, as the pawl assembly 116 is in the pawl assembly disengaged position, the movement of the arm 108 will not affect the output shaft 114.

Referring again to FIGS. 10 and 11, after the spring 137 has unwound, the electromechanical assembly 155 moves the ratchet assembly 113 from the disengaged position back to the engaged position. This may be done, for example, after a specific period of time lapsed. For example, the electromechanical assembly 155 may be configured to move the ratchet assembly 113 from the disengaged position back to the engaged position 5 to 10 seconds after the clutch assembly 117 has been moved to the disengaged position. The specific time period may be selected based on the amount of time typically required for the spring 137 to unwind. Alternately, one or more sensors may be provided, which determine when the spring 137 has unwound.

In order to move the ratchet assembly 113 from the disengaged position back to the engaged position, the control unit 157 first moves clutch assembly 117 back to the clutch assembly engaged position. Specifically, the control unit moves the second sliding arm 167 in the direction indicated by arrow A7, which moves the second bracket in the direction indicated by arrow A7, so that the second toothed 154 surface contacts and engages the first toothed surface 153 to prevent rotation of the first toothed surface 153 in the second direction.

The control unit 157 then moves the pawl assembly 116 back to the pawl assembly engaged position. Specifically, the control unit 157 again moves the first sliding arm 160 in the direction indicated by arrow A9, so that the toothed face 165 of the shaft 161 engages the toothed face 166 of the arm. The control unit then rotates the shaft in a direction indicated by arrow A15 in FIG. 10, to rotate the control shaft 132 in the direction indicated by arrow A5 in FIG. 7B. The rotation of the control shaft 132 moves the plunger 131 from the second angular position to the first angular position, which rotates the pawl 122 from the second pivotal position to the first pivotal position. Accordingly, the toothed pawl re-engages the cylinder 118, and rotation of the cylinder 118 in the first direction again induces orbital rotation of the toothed pawl 122 in the first direction about the longitudinal axis 115 of the cylinder 118.

When the ratchet assembly 113 has been moved back to the ratchet assembly engaged position, the movement of the chassis 101 with respect to the axle 102 will again begin to cause tightening of the torsion spring 137. The sequence of tightening the torsion spring 137, and moving the ratchet assembly 113 to the disengaged position so that the torsion spring 137 unwinds and rotates the output shaft 114 in the second direction to generate energy is then repeated.

Although in the embodiment shown, the vehicle 100 is an automobile, in alternate examples, the vehicle may be another vehicle in which vertical displacement between two parts of the vehicle occurs during use. For example, the vehicle may be an aircraft, a boat, a motorcycle, a bicycle, a scooter, a truck, a two-wheeled self-balancing electric vehicle (such as those sold under the trademark Segway™), a train, a carriage, a cart, a snowmobile, an amphibious vehicle, or an all terrain vehicle. In such embodiments, the arm may be mounted between a first portion and a second portion of the vehicle which are vertically displaced with respect to each other.

In the embodiments described hereinabove, the unwinding of the torsion spring induces rotation of the output shaft in the second direction, and the rotational energy of the output shaft in the second direction is converted to electrical energy by the generator. In an alternate embodiment (not shown) a second output shaft may be provided in addition to the main output shaft, and the second output shaft may be connected to the torsion spring and the generator. The rotation of the main output shaft in the first direction may wind the torsion spring, and the unwinding of the torsion spring may induce rotation of the second output shaft. The generator may be coupled to the second output shaft such that the rotational energy of the second output shaft is converted to electrical energy.

1. An energy recovery system for converting vehicle motion into electrical power comprising:
a) an arm mounted between a chassis of the vehicle and an axle of the vehicle, the arm pivotably mounted at first and second opposed ends thereof and configured to pivot with respect to the chassis and the axle when the chassis is vertically displaced with respect to the axle;
b) a one-way ratchet assembly coupling the arm to an output shaft, the ratchet assembly movable between:
i) an engaged position wherein the ratchet assembly induces rotation of the output shaft in a first direction about a longitudinal axis thereof when the arm pivots in the first direction, and prevents rotation of the output shaft in a second direction opposite the first direction; and
ii) a disengaged position wherein the ratchet assembly does not prevent rotation of the output shaft in the second direction;
c) a torsion spring coupled to the output shaft such that when the output shaft is rotated in the first direction, the torsion spring is tightened so that rotational energy of the output shaft is stored as potential energy in the torsion spring;
d) an electromechanical assembly coupled to the ratchet assembly, the electromechanical assembly configured to move the ratchet assembly from the engaged position to the disengaged position when the torsion spring reaches a pre-determined tightness, so that when the ratchet assembly is in the disengaged position the torsion spring loosens and induces rotation of the output shaft in the second direction; and
e) a generator coupled to the output shaft and configured to convert rotational energy of the output shaft into electrical energy.

2. The energy recovery system of claim 1, wherein the one-way ratchet assembly comprises a pawl assembly moveable between a pawl assembly engaged position and a pawl assembly disengaged position, wherein when the pawl assembly is in the pawl assembly engaged position, the pawl assembly induces the rotation of the output shaft in the first direction when the arm pivots in the first direction.

3. The energy recovery system of claim 2, wherein the one-way ratchet assembly further comprises a clutch assembly moveable between a clutch assembly engaged position and a clutch assembly disengaged position, wherein when the clutch assembly is in the clutch assembly engaged position, the clutch assembly prevents the rotation of the output shaft in the second direction.

4. The energy recovery system of claim 3, wherein the ratchet assembly is in the engaged position when the clutch assembly is in the clutch assembly engaged position and the pawl assembly is in the pawl assembly engaged position.

5. The energy recovery system of claim 4, wherein the pawl assembly comprises a cylinder extending collinear to the output shaft and having a toothed bore extending longitudinally therethrough, the cylinder coupled to the second end of the arm such that when the arm pivots in the first direction, the cylinder rotates about a longitudinal axis thereof in the first direction.

6. The energy recovery system of claim 5, wherein the pawl assembly further comprises a toothed pawl received in the toothed bore and engaging the toothed bore when the pawl assembly is in the pawl assembly engaged position, wherein when the toothed pawl engages the toothed bore, rotation of the cylinder in the first direction induces orbital rotation of the toothed pawl in the first direction about the longitudinal axis of the cylinder.

7. The energy recovery system of claim 6, wherein the toothed pawl is coupled to the output shaft such that the orbital rotation of the toothed pawl in the first direction induces the rotation of the output shaft in the first direction.

8. The energy recovery system of claim 7, wherein the pawl assembly further comprises a pivot pin about with the toothed pawl is pivotal, and the orbital rotation of the toothed pawl induces orbital rotation of the pivot pin about the longitudinal axis of the cylinder.

9. The energy recovery system of claim 8, wherein the pivot pin is mounted to the output shaft, such that that the orbital rotation of the toothed pawl in the first direction induces the rotation of the output shaft in the first direction via the pivot pin.

10. The energy recovery system of claim 9, wherein:
a) when the pawl assembly is in the pawl assembly engaged position, the toothed pawl is pivoted about the pivot pin to a first pivotal position wherein the toothed pawl engages the toothed bore; and
b) when the pawl assembly is in the pawl assembly disengaged position, the toothed pawl is pivoted about the pivot pin to a second pivotal position.

11. The energy recovery system of claim 10, wherein the toothed pawl is moved between the first pivotal position and the second pivotal position by movement of a plunger between a first angular position and a second angular position with respect to the toothed pawl.

12. The energy recovery system of claim 11, wherein the plunger is mounted to a control shaft extending collinear to the output shaft, and the plunger is moved between the first angular position and the second angular position by rotation of the control shaft.

13. The energy recovery system of claim 12, wherein the control shaft is rotated by the electromechanical assembly.

14. The energy recovery system of claim 3, wherein the clutch assembly comprises:
a) a first toothed surface mounted to the output shaft such that rotation of the output shaft in the first direction induces rotation of the first toothed surface in the first direction, and
b) a second toothed surface moveable towards and away from the first toothed surface by the electromechanical assembly and rotationally fixed with respect to the output shaft.

15. The energy recovery system of any of claim 1, wherein the torsion spring is at least partially received in a housing comprising at least one catch on an inner surface thereof.

16. The energy recovery system of claim 15, wherein the torsion spring is tightened by winding of a first end thereof about a spring axis, and wherein a second end thereof is releasably secured to the catch.

17. The energy recovery system of claim 16, wherein the spring reaches the predetermined tightness when a force required to maintain the second end of the spring secured to the catch is less than a force required to continue winding the first end of the spring.

18. The energy recovery system of claim 17, wherein when the spring reaches the predetermined tightness, the second end of the spring is released from the catch and the spring rotates about the spring axis.

19. An energy recovery system for converting vehicle motion into electrical power comprising:
a) an arm mounted between a first portion of the vehicle and a second portion of the vehicle, the arm pivotably mounted at first and second opposed ends thereof and configured to pivot with respect to the first portion and the second portion when the first portion is displaced with respect to the second portion;
b) a one-way ratchet assembly coupling the arm to an output shaft, the ratchet assembly movable between:
i) an engaged position wherein the ratchet assembly induces rotation of the output shaft in a first direction about a longitudinal axis thereof when the arm pivots in the first direction, and prevents rotation of the output shaft in a second direction opposite the first direction; and
ii) a disengaged position wherein the ratchet assembly does not prevent rotation of the output shaft in the second direction;
c) a torsion spring coupled to the output shaft such that when the output shaft is rotated in the first direction, the torsion spring is tightened so that rotational energy of the output shaft is stored as potential energy in the torsion spring;
d) an electromechanical assembly coupled to the ratchet assembly, the electromechanical assembly configured to move the ratchet assembly from the engaged position to the disengaged position when the torsion spring reaches a pre-determined tightness, so that when the ratchet assembly is in the disengaged position the torsion spring loosens and induces rotation of the output shaft in the second direction; and
e) a generator coupled to the output shaft and configured to convert rotational energy of the output shaft into electrical energy.

20. An energy recovery system for converting vehicle motion into electrical power comprising:
a) an arm mounted between a chassis of the vehicle and an axle of the vehicle, the arm pivotably mounted at first and second opposed ends thereof and configured to pivot with respect to the chassis and the axle when the chassis is vertically displaced with respect to the axle;
b) a one-way ratchet assembly coupling the arm to an output shaft, the ratchet assembly movable between:
i) an engaged position wherein the ratchet assembly induces rotation of the output shaft in a first direction about a longitudinal axis thereof when the arm pivots in the first direction, and prevents rotation of the output shaft in a second direction opposite the first direction; and
ii) a disengaged position wherein the ratchet assembly does not prevent rotation of the output shaft in the second direction;
c) a torsion spring coupled to the output shaft such that when the output shaft is rotated in the first direction, the torsion spring is tightened so that rotational energy of the output shaft is stored as potential energy in the torsion spring;
d) an electromechanical assembly coupled to the ratchet assembly, the electromechanical assembly configured to move the ratchet assembly from the engaged position to the disengaged position when the torsion spring reaches a pre-determined tightness, so that when the ratchet assembly is in the disengaged position the torsion spring loosens and induces rotation of a second output shaft; and
e) a generator coupled to the second output shaft and configured to convert rotational energy of the second output shaft into electrical energy.
